(19) United States
(12) Patent Application Publication
(10) Pub. No.: US 2011/0310601 A1
(43) Pub. Date: Dec. 22, 2011

(54) Light-emitting diode line lamp

(76) Inventor: Shu-Fa Shao, Lu-Chou City (TW)

(21) Appl. No.: 12/071,157

(22) Filed: Feb. 15, 2008

(51) Int. Cl. F21S 2/00; F21S 4/00

(52) U.S. Cl. 362/231; 362/249.04

(57) ABSTRACT

An LED line lamp provides a lamp string design which is simple in structure, small in volume, used conveniently, not fractured easily, and supplies a free creation space to common people. Plural LED lamps are connected serially on an electric wire depending on a pre-determined distance, and an end of the wire is disposed with a power connection element to be directly connected with a battery or an adapter for supplying electricity. A supporter which is harder than the wire is located at the LED lamp position, and can display light of the LED lamp. By softness of the electric wire, a required shining shape can be arranged freely according to pre-determined texts or patterns, and the LED lamp position can be protected by the supporter that it will not be damaged upon bending the wire, allowing an operation to be safer and more smoothly.

### BACKGROUND OF THE INVENTION

a) Field of the Invention

The present invention relates to an LED (Light-Emitting Diode) line lamp, and more particularly to an LED line lamp which is provided with a simple operating structure, is operated conveniently, has a small volume, and can be used to arrange into required shining models depending on pre-determined texts or patterns.

b) Description of the Prior Art

No matter a lamp bank for decoration, a pre-determined pattern or a nonspecific clip strip arranged by LED lamps or small light bulbs, it is provided with a complicated structure which is large and awkward. For a pattern in an ordinary festival or assembly room or a shining design of a personal hand-held billboard, some of them are made by bending neon tubes, and some of them are made by connecting LED string lamps or Christmas lamps serially. As this kind of approach involves a complex electric structure, it cannot be handled by general population and should be implemented by a professional. For example, as shown in FIG. 1, a pattern of a most common hand-held billboard 20 is made by arranging illuminators 24, such as LED lamps or light bulbs with small watts. Its installation method is to provide holes 21 on a pre-determined pattern, install the illuminators 24 on a front surface of the billboard 20, and connect the illuminators 24 with a wire 22 at a rear surface serially (as shown in FIG. 2); whereas, electricity is provided by a set of battery 23. However, this approach cannot be made by an ordinary people and costs a lot.

Accordingly, disregarding what kind of lamp bank design, a free creation space is not available to general public. Therefore, a kind of line lamp structure which is simple, convenient, economic, and practical is developed to provide the common people with shining patterns required in the free creation, such as embodiments of creation in FIGS. 3 to 5 and annex 1.

### SUMMARY OF THE INVENTION

The primary object of the present invention is to provide an LED line lamp which is simple in structure, small in volume, used conveniently, not fractured easily, and provides common people with a space of free creation.

A second object of the present invention is to provide an LED line lamp wherein LED lamps are provided at certain distances on an electric wire, and a supporter is provided at each LED lamp along with its bare wire location to enhance hardness at that place, such that that place can be avoided automatically without being bended to be damaged, when bending the wire to design a pattern, thereby enabling an operation to be safer and more smoothly.

A third object of the present invention is to provide an LED line lamp which uses a thinner wire, enabling an operation to be easier.

A fourth object of the present invention is to provide an LED line lamp wherein each LED lamp can be provided with two anti-phased light emitting diodes of different colors, such that by changing a setting of electrodes of a control circuit, a visual effect that different colored lamps are flashing can be achieved.

A fifth object of the present invention is to provide an LED line lamp, wherein LED lamps formed by light emitting diodes of colors in RGB (Red-Green-Blue) can be used, so as to provide a more versatile feature.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a conventional billboard.

FIG. 2 shows a rear view of FIG. 1.

FIG. 3 shows a schematic view of an embodiment of the present invention, which is implemented on a billboard.

FIG. 4 shows a blow-up view at a part Y in FIG. 3.

FIG. 5 shows a schematic view of an embodiment of the present invention, which is implemented on a piece of clothes.

FIG. 6 shows a schematic view of a supporter of the present invention.

FIG. 7 shows a schematic view of an embodiment of structures of the present invention.

FIG. 8 shows a schematic view of another embodiment of a supporter of the present invention.

FIG. 9 shows a schematic view of a third embodiment of a supporter of the present invention.

FIG. 10 shows a circuit diagram of an embodiment of the present invention.

FIG. 11 shows a schematic view of an embodiment of the present invention, including a control circuit.

FIG. 12 shows a circuit diagram of the present invention, wherein LED lamps illuminate separately.

FIG. 13 shows a circuit diagram of an embodiment of another kind of LED lamp group.

FIG. 14 shows a circuit diagram of an embodiment of an LED lamp set having two light emitting diodes.

FIG. 15 shows a schematic view of an embodiment of an LED lamp with colors in RGB.

FIG. 16 shows a circuit diagram of FIG. 15.

FIG. 17 shows a schematic view of another embodiment of a thermal shrinkable sleeve supporter.

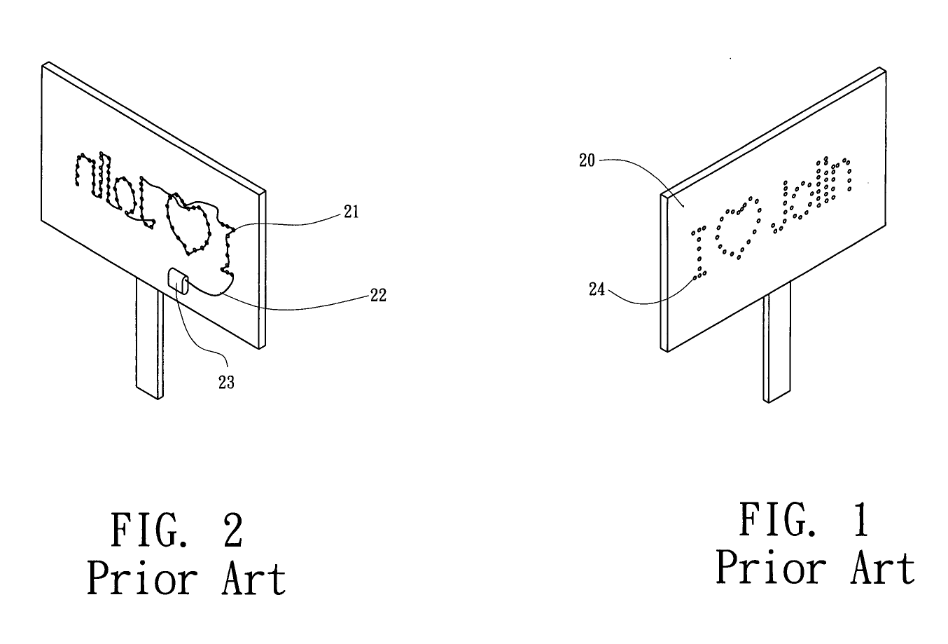

### DETAILED DESCRIPTION OF THE PREFERRED EMBODIMENTS

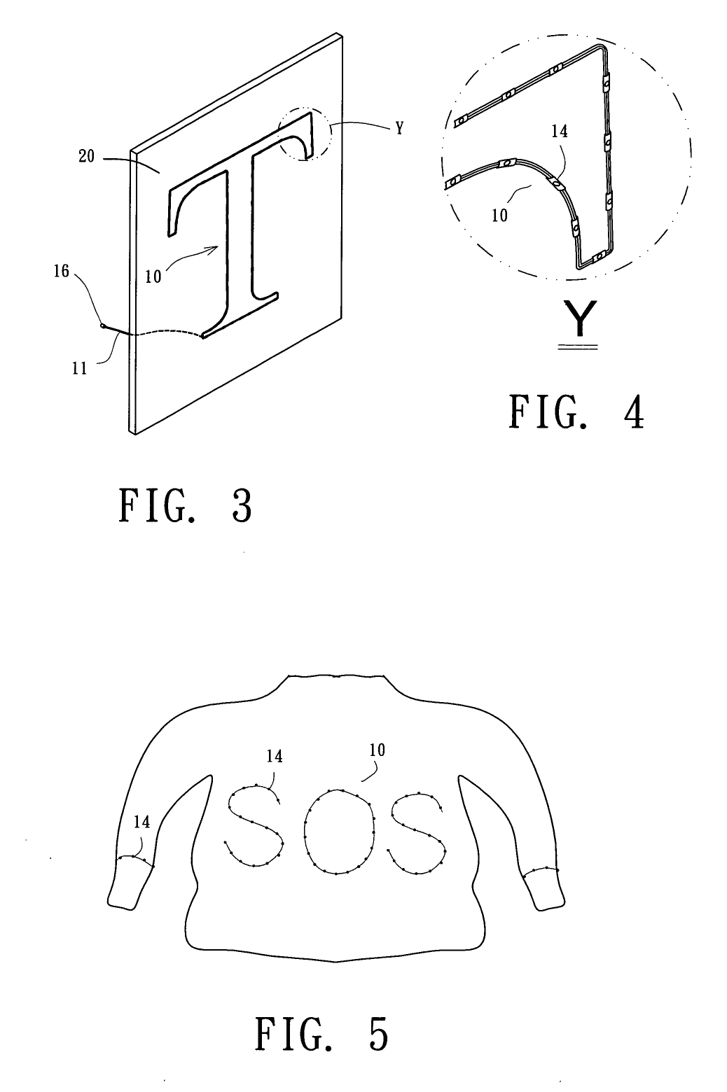

Referring to FIG. 3, for a pattern design on a billboard 20, a user can print or draw a required pattern on the billboard 20, arrange a line lamp into a profile depending on the pattern, and then fix by thumb pins, a tape, or glue. After an electric wire 11 has been transfixed out of the billboard 20, electricity is supplied by a battery or an adapter through a power connection element 16. Therefore, the user can arrange the line lamp of the present invention in accordance with the pattern designed easily and safely, without asking for a professional to implement. In this embodiment, the arrangement follows an outline of a letter, but the arrangement of filling a letter can be also made.

For another embodiment, as the present invention saves energy that the electricity can be supplied by the battery, the line lamp 10 can be sewn on a coat to prevent from a mountaineering accident or other accidents (as shown in FIG. 5), and the coat can be also carried personally while climbing a mountain, such that once an accident occurs, the line lamp 10 can be used as a rescue signal at any time; in addition, its illumination method can be configured as a timed flashing mode, naturally.

Referring to FIG. 4 and FIG. 5, LED lamps of the line lamps 10 are all covered by supporters 14 to have functions of water-proofing and protecting the LED lamps. The implementation method of the supporters 14 will be described later.

Actually, the aforementioned embodiments describe that all kinds of variations of the LED line lamp of the present invention are due to that the LED line lamp is light in weight, small in volume, and can save energy, so as to be used conveniently in a festival, an assembly room, or a party, according to a personal creation such as an outline of a doll and a pattern shape, which are all a simple application of the present invention.

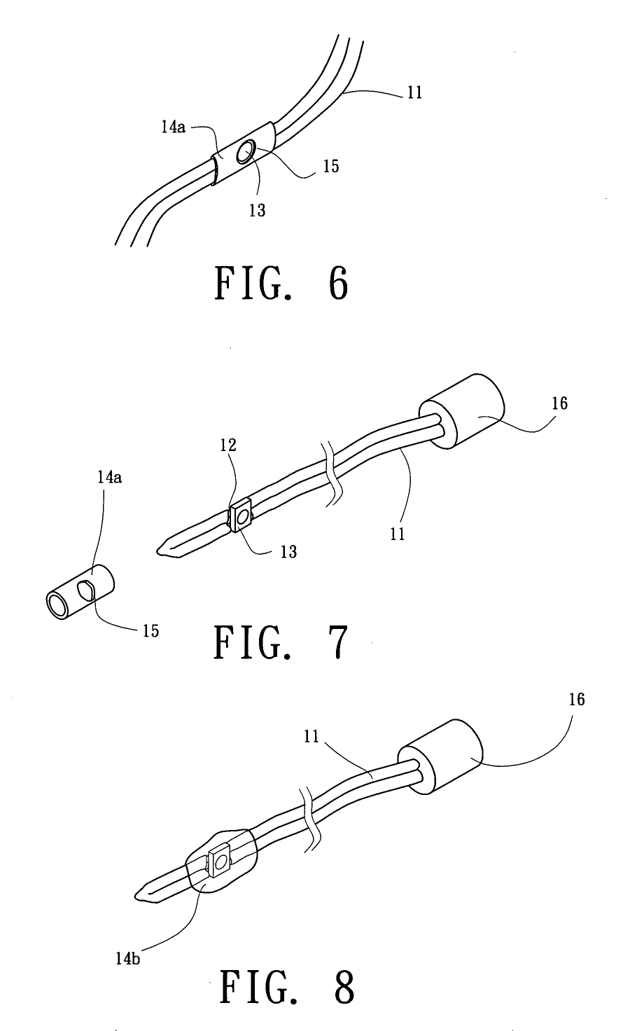

The LED line lamp of the present invention is characterized by two aspects. In addition to that a shining pattern can be freely created, when the user is freely bending the line lamp for creation, there is no concern that the LED lamp will be damaged by bending. Referring to FIG. 6 and FIG. 7, an end of the electric wire 11 is provided with a stop end, the other end is disposed with the power connection element 16, and a plurality of LED lamps 13 are welded on the electric wire 11 at a certain distance. In order to prevent a welding position of the LED lamp 13 and a bare wire 12 from being bended to result in an unexpected damage when the user is bending the LED lamp 13 for shaping, a supporter is additionally located at that position and can display light of the LED lamp 13. As shown in FIG. 6 and FIG. 7, an embodiment of the supporter is a thermal shrinkable sleeve 14a which is provided with a hole position 15. When the LED lamp 13 is sheathed in, the hole position 15 can exactly display the light of the LED lamp 13. After positioning the thermal shrinkable sleeve 14a, a blower or a similar heater is used to heat up the thermal shrinkable sleeve 14a, and the thermal shrinkable sleeve 14a will be shrunk to tightly wrap the position of the LED lamp 13, which can increase intensity at that area, and is also provided with a water-proofing effect. In other words, if the LED lamp 13 is just at the bending position, then it will be protected by the supporter, and the bending will be carried out at the supporter end.

Referring to FIG. 3 and FIG. 4, it shows that if the LED lamp 13 is protected by the thermal shrinkable sleeve 14a, then the LED lamp 13 can be prevented from being bended.

In addition to the thermal shrinkable sleeve 14a, a scotch tape 14b can be also used as the supporter. Referring to FIG. 8, the LED lamp 13 is added with the scotch tape 14b which can display the light of the LED lamp 13 and also increase hardness of the LED lamp area. On the other hand, to put the scotch tape 14b on the LED lamp 13 as the supporter can be also quickly achieved by a finishing with an extrusion machine.

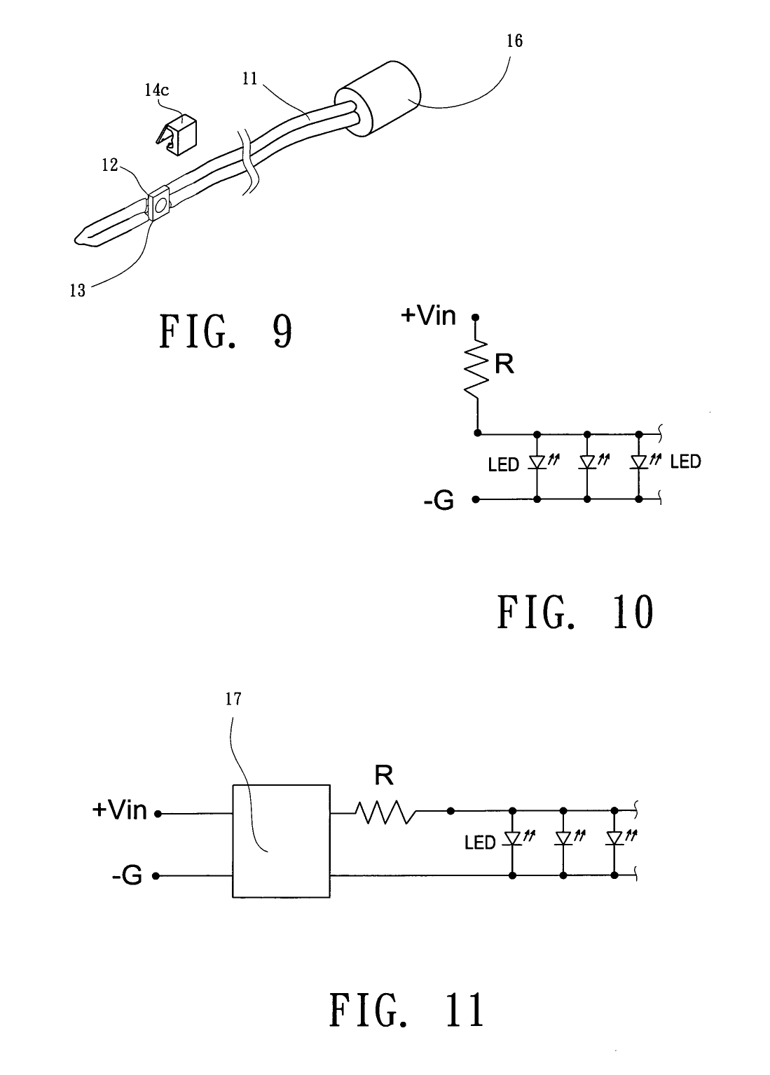

Furthermore, referring to FIG. 9, a finishing method like using a cover 14c with top and bottom hard materials can be also used to achieve a result for protecting the bare wire 12 and the LED lamp 13.

Referring to FIG. 10, it shows a simple circuit diagram of the LED line lamp of the present invention, wherein a plurality of LEDs are serially connected on an electric wire to illuminate after being energized. If the LEDs are to be provided with a timed flashing effect, then a control circuit 17 can be added, as shown in FIG. 11.

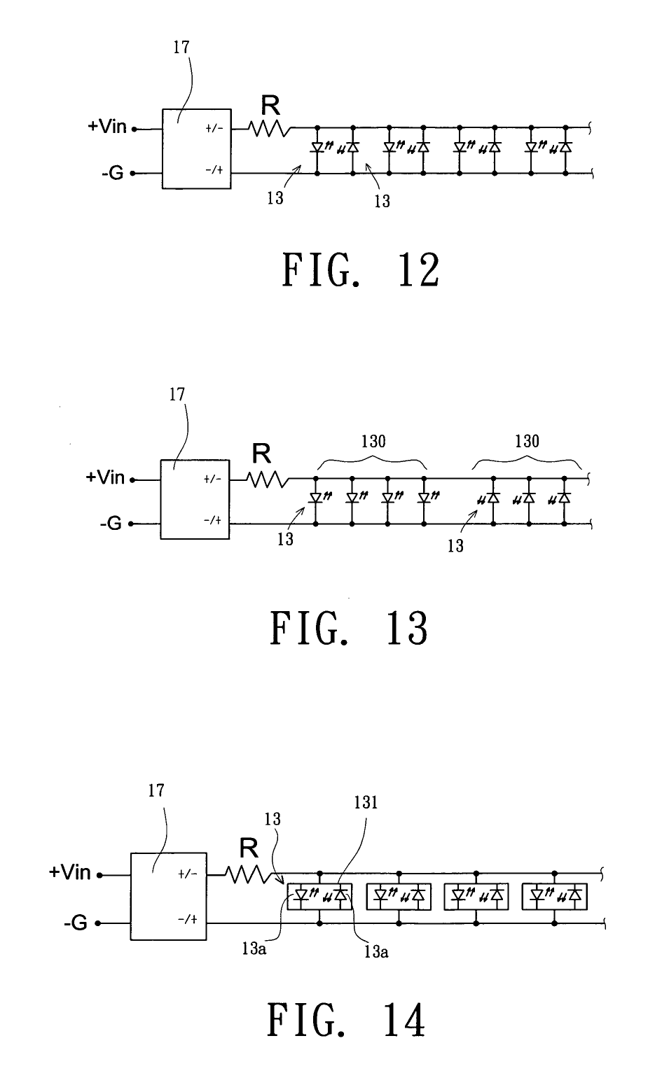

Referring to FIG. 12, in order to allow the LED lamps 13 of the line lamp to illuminate intermittently, the LED lamps 13 can be serially connected with their electrodes being anti-phased alternately, and by using the control circuit 17 to switch between the positive and negative electrodes at a constant time period, the LED lamps 13 at different electrode positions can illuminate separately at the constant time period. Accordingly, an effect of colored lamps flashing at different times can be resulted, in association with the LED lamps of different colors. If an interval of switching between the positive and negative electrodes can be controlled to a tiny value, then it will cause a visual effect as if the LED lamps 13 of different colors illuminate at a same time.

Referring to FIG. 13, plural LED lamps with a same electrode phase are disposed as a group 130 in a front and a rear position alternately. Therefore, a shining effect of group flashing can be intensified by switching the electrodes.

Referring to FIG. 14, it shows another way to achieve an alternate flashing of different colored lamps, wherein a substrate 131 of each LED lamp 13 is provided with two light emitting diodes 13a of opposite electrode phases, and when the electrodes are switched by the control circuit 17, the positive-phase light emitting diodes on the substrates 131 are energized to illuminate.

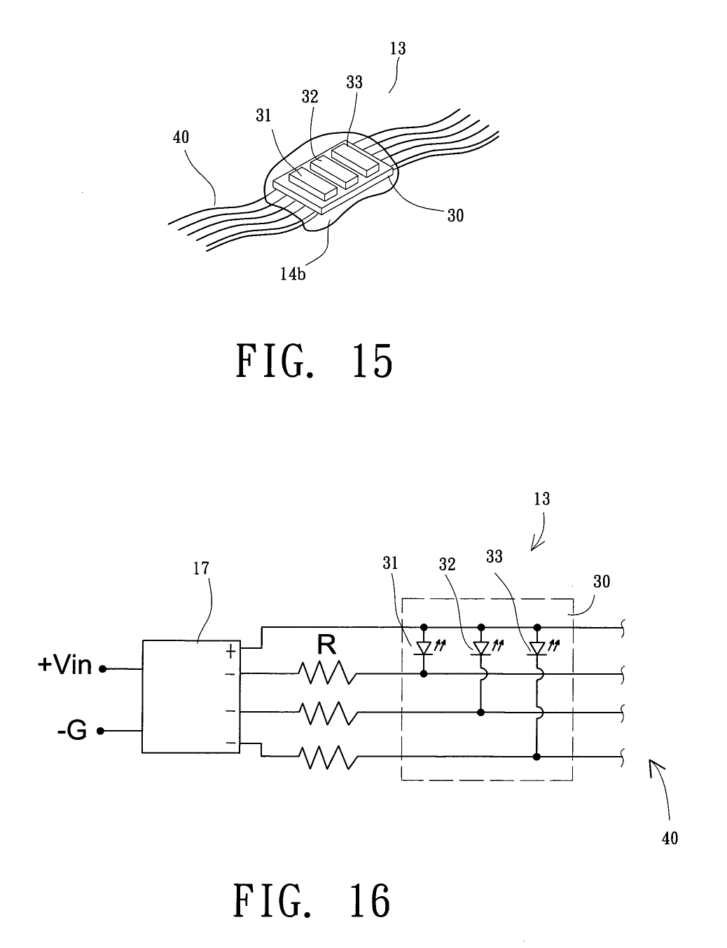

Referring to FIG. 15, the LED lamp 13 of the LED line lamp of the present invention is also provided with an effect of RGB (red, green and blue) colors, wherein a substrate 30 is provided with light emitting diodes 31, 32, 33 of red, green, and blue, respectively, and an electric wire 40 with four conductive wires is connected with the substrate 30, such that three loops can be formed by the light emitting diodes 31, 32, 33 and electrode lines of the electric wire 40, respectively. The supporter used in the drawing is a scotch tape 14b, and FIG. 16 shows a circuit diagram of an embodiment that the light emitting diodes 31, 32, 33 are connected with the four electrode lines of the electric wire 40. Therefore, by using the control circuit 17 to control a loop condition and a setting of polarities of the light emitting diodes 31, 32, 33 of different RGB colors, the pre-determined shining effect of different flashing in RGB colors can be achieved. In other words, a design object of a fancy and versatile color shining is achieved.

As the LED line lamp of the present invention is provided with the supporter to tightly wrap the LED lamp and a bare wire junction, it can be sewn on clothes to be washed together, by having the water-proofing feature. From a test, it is found that an electric wire of 2 mm is preferable to achieve results of light-weight and of an easy operation. Certainly, different wire diameters, LED lamps, and adapters can be selected for use depending on a design of place, range, and vista.

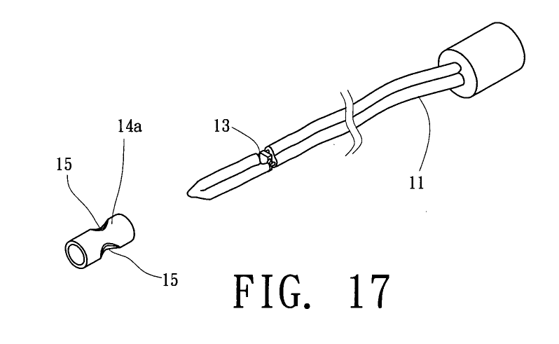

For the LED line lamp of the present invention, referring to FIG. 17, two opposite holes can be provided at the hole position 15 of the thermal shrinkable sleeve 14a to transmit the light of the LED lamp 13, and to enable the light of the LED lamp 13 to irradiate toward a same direction of the electric wire 11. This method can lead the light source of the LED lamp 13 to an edge of the electric wire 11 through two opposite holes of the sleeve 14a, so as to increase a viewable angle of the light source.

The LED line lamp of the present invention is provided with a simple structure, is convenient to operate, is applied broadly, and allows a user to freely create a shining effect, thereby accurately having a value of practicability and an economic benefit.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An LED (Light-Emitting Diode) line lamp, being a plurality of LED lamps connected serially on pre-determined positions of an electric wire, an end of the electric wire being a power connection element through which electricity is supplied by a battery or an adapter, wherein each LED lamp position is provided with a supporter which wraps an area covering the LED lamp and a bare wire, and displays light of the LED lamp, allowing a user to freely create a shining shape using the line lamp, and preventing a connection place between the LED lamp and the bare wire from being bended to be damaged, under a protection of the supporter.

2. The LED line lamp according to claim 1, wherein the supporter is a thermal shrinkable sleeve, and a hole is located at a position of an LED lamp.

3. The LED line lamp according to claim 1, wherein the supporter is a scotch tape.

4. The LED line lamp according to claim 1, wherein the supporter is a cover with top and bottom hard materials.

5. The LED line lamp according to claim 1, wherein the LED lamp is provided with at least one light emitting diode.

6. The LED line lamp according to claim 1, wherein the LED lamp is provided with more than two light emitting diodes, electrodes of which are anti-phased.

7. An LED line lamp comprising an electric wire which is provided with at least four electrode lines; a power connection element which is connected with a control circuit and supplies power to LED lamps; the control circuit and LED lamps; and supporters which wrap positions of the LED lamps and bare wires; wherein the LED lamp is composed of a substrate and light emitting diodes of RGB (red, green and blue) colors, with the light emitting diodes of RGB colors being located on the substrate, allowing electrode lines of different polarities to be connected with the light emitting diodes of red, green, and blue to form a loop, respectively, thereby enabling the line lamp to be provided with a shining control effect in three different colors.
